(19) United States
(12) Patent Application Publication
(10) Pub. No.: US 2012/0012485 A1
(43) Pub. Date: Jan. 19, 2012

(54) HEXAGONAL WRENCH HOLDING ASSEMBLY

(76) Inventor: Tzu-Chien Wang, Tainan City (TW)

(21) Appl. No.: 12/834,990

(22) Filed: Jul. 13, 2010

(51) Int. Cl. B25H 3/00

(52) U.S. Cl. 206/377

(57) ABSTRACT

A hexagonal wrench holding assembly has a holding mount and a protecting cover. The holding mount has a body. The body has multiple mounting grooves, a pivotal base and a locking recess. The protecting cover is pivotally connected to the holding mount and has a casing. The casing is pivotally connected to and mounted around the body and has two ends, a pivotal rod and a locking protrusion. The pivotal rod is formed on one of the ends of the casing and is pivotally connected to the pivotal base. The locking protrusion is formed on the other end of the casing and is locked with the locking recess to allow the protecting cover holding securely with the holding mount and this can provide a burglarproof effect.

### BACKGROUND OF THE INVENTION

1. Field of the Invention

The present invention relates to a holding assembly, especially to a hexagonal wrench holding assembly that can hold the hexagonal wrenches easily and can provide a burglarproof effect.

2. Description of the Prior Arts

With reference to FIG. 7, a conventional hexagonal wrench holding assembly is used to hold the hexagonal wrenches 30 and has an inserting mount 40. The inserting mount 40 has multiple inserting holes 41. The inserting holes 41 are formed through the inserting mount 40 and each inserting hole 41 has a diameter. The diameters of the inserting holes 41 are different and the inserting holes 41 are ranged in the inserting mount 40 according to the diameter. The hexagonal wrenches 30 are inserted in the inserting holes 41 of the inserting mount 40 according to the sizes. A hexagonal wrench 30 of a large size is mounted over another one of a small size.

When a user wants to use the hexagonal wrench 30 of a small size, the hexagonal wrench 30 is obstructed from the other hexagonal wrenches 30 in large sizes. Therefore, the hexagonal wrench 30 of a small size can not be directly pulled out of a corresponding inserting hole 41 before removing or rotating the hexagonal wrenches 30 in large sizes and this is inconvenient in used. In addition, the inserting mount 40 of the conventional hexagonal wrench holding assembly can not provide a burglarproof effect and the hexagonal wrenches 30 may be unauthorizedly removed.

To overcome the shortcomings, the present invention provides a hexagonal wrench holding assembly to mitigate or obviate the aforementioned problems.

### SUMMARY OF THE INVENTION

The main objective of the present invention is to provide a hexagonal wrench holding assembly that can hold the hexagonal wrenches easily and can provide a burglarproof effect.

The hexagonal wrench holding assembly in accordance with the present invention has a holding mount and a protecting cover. The holding mount has a body. The body has multiple mounting grooves, a pivotal base and a locking recess. The protecting cover is pivotally connected to the holding mount and has a casing. The casing is pivotally connected to and mounted around the body and has two ends, a pivotal rod and a locking protrusion. The pivotal rod is formed on one of the ends of the casing and is pivotally connected to the pivotal base. The locking protrusion is formed on the other end of the casing and is locked with the locking recess to allow the protecting cover holding securely with the holding mount and this can provide a burglarproof effect.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hexagonal wrench holding assembly in accordance with the present invention with multiple hexagonal wrenches being mounted therein;

FIG. 2 is an exploded perspective view of the hexagonal wrench holding assembly in FIG. 1;

FIG. 3 is a side view in partial section of the hexagonal wrench holding assembly in FIG. 1;

FIG. 4 is an operational side view in partial section of the hexagonal wrench holding assembly in FIG. 1;

FIG. 5 is an operational perspective view of the hexagonal wrench holding assembly in FIG. 1 showing one of the hexagonal wrenches being removed;

FIG. 6 is a bottom view of the hexagonal wrench holding assembly in FIG. 1; and

FIG. 7 is a perspective view of a convention hexagonal wrench holding assembly in accordance with the prior art with multiple hexagonal wrenches being mounted thereon.

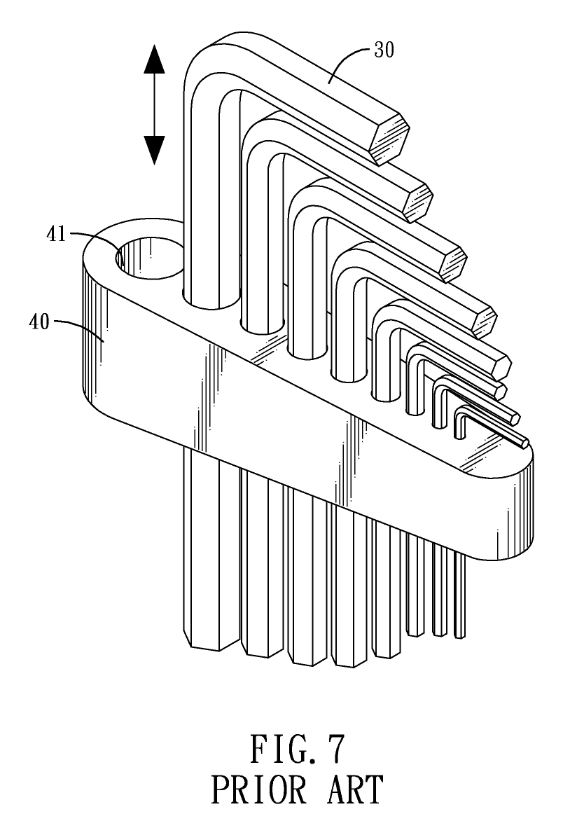

### DETAILED DESCRIPTION OF PREFERRED EMBODIMENTS

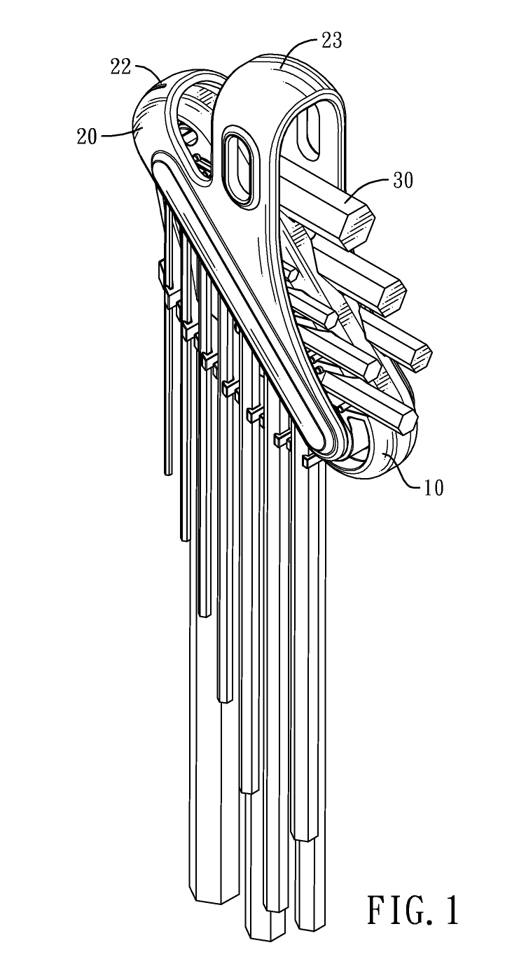

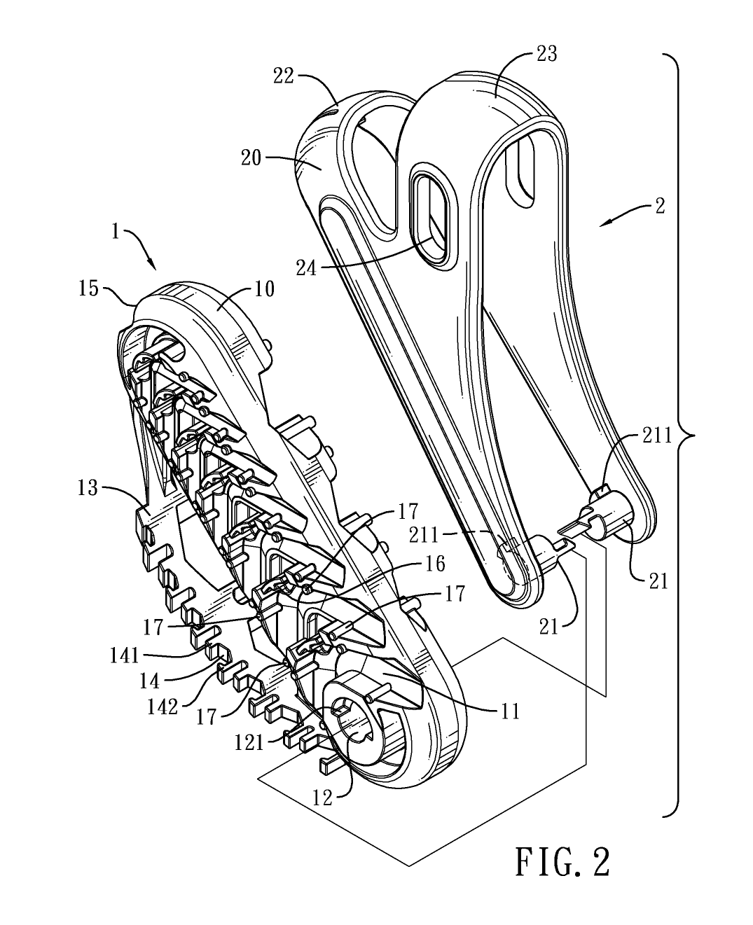

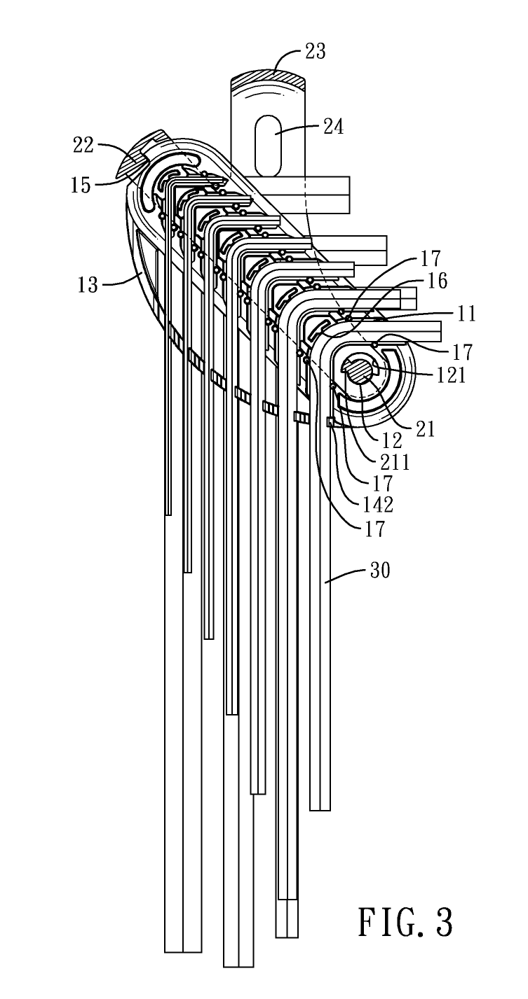

With reference to FIGS. 1 to 3, a hexagonal wrench holding assembly in accordance with the present invention has a holding mount 1 and a protecting cover 2.

The holding mount 1 has a body 10. The body 10 has two outer sides, a connecting end, a bottom, a top, multiple mounting grooves 11, a pivotal base 12, a fixed seat 13 and a locking recess 15.

The mounting grooves 11 may be curved corresponding to the curved segment of the hexagonal wrenches 30 and are formed in the outer sides of the body 10 at intervals and each mounting groove 11 has two internal surfaces, a middle, multiple holding protrusions 17 and a spacer 16. The holding protrusions 17 are formed on and protrude from the internal surfaces of the mounting groove 11 to abut and hold a corresponding hexagonal wrench 30. The spacer 16 may be curved, is formed on and protrudes from the middle of the mounting groove 11 and has an inner protrusion to hold the corresponding hexagonal wrench 30.

The pivotal base 12 is formed on and protrudes from the connecting end of the body 10 and has a pivot hole and two positioning blocks 121. The pivot hole is formed through the pivotal base 12 and has an inner surface and two ends. The positioning blocks 121 are formed on and protrude from the inner surface respectively at the ends of the pivot hole and each positioning block 121 has two ends.

The fixed seat 13 may be curved, is formed on the bottom of the body 10 and has two sidewalls and multiple holding recesses 14. The holding recesses 14 are formed in the sidewalls of the fixed seat 13, respectively align with the mounting grooves 11 and each holding recess 14 has two sides, an abutting arm 141 and a holding claw 142. The abutting arm 141 is formed on one of the sides of the holding recess 14. The holding claw 142 is formed on and protrudes from the other side of the holding recess 14.

The locking recess 15 is formed on and protrudes from the top of the body 10 at an end opposite to the pivotal base 12.

The protecting cover 2 is pivotally connected to the holding mount 1 and has a casing 20. The casing 20 is pivotally connected to and mounted around the body 10 and has two ends, two pivotal rods 21, a locking protrusion 22 and a hanging segment 23.

The pivotal rods 21 are formed on one of the ends of the casing 20, are pivotally connected respectively to the ends of the pivotal base 12 and each pivotal rod 21 has an outer surface and an inserting protrusion 211. The inserting protrusion 211 is formed on and protrudes from the outer surface of the pivotal rod 21 and is mounted slidably in a corresponding end of the pivot hole of the pivotal base 12 and selectively abuts with one of the ends of the positioning block 121 in the corresponding end of the pivotal base 12 to prevent the casing 20 from over-rotating to knock against the hexagonal wrenches 30.

The locking protrusion 22 is formed on the other end of the casing 20 and engages the locking recess 15 of the body 10 to hold the protecting cover 2 securely with the holding mount 1. Thus, the hexagonal wrenches 30 can be held securely in the hexagonal wrench holding assembly between the holding mount 1 and the cover 2 to prevent unauthorized removal.

The hanging segment 23 is formed on the casing 20 between the pivotal rods 21 and the locking protrusion 22 and has two sidewalls and two hanging holes 24. The hanging holes 24 are respectively formed through the sidewalls of the hanging segment 23. Thus, the hexagonal wrench holding assembly can be hung on the waist or a hook by the hanging holes 24 of the hanging segment 23.

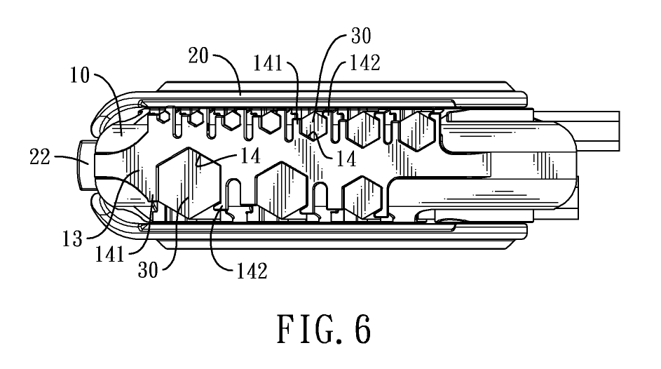

In use, with further reference to FIGS. 1 to 3 and 6, the L-shaped hexagonal wrenches 30 in different sizes are mounted respectively in the mounting grooves 11 of the body 10. The spacers 16 and the holding protrusions 17 can hold the hexagonal wrench 30 securely in the mounting grooves 11 of the body 10 and the fixed seats 13 provide a further holding effect to the hexagonal wrench 30 by the abutting panels 141 and the holding claws 142. With the casing 20 covering over the body 10 of holding mount 1 and the locking protrusion 22 engaging the locking recess 15 on the body 10, the hexagonal wrenches 30 can be securely mounted in the hexagonal wrench holding assembly and cannot be taking out of the hexagonal wrench holding assembly unauthorizedly. Thus, a burglarproof effect to the hexagonal wrenches 30 is provided.

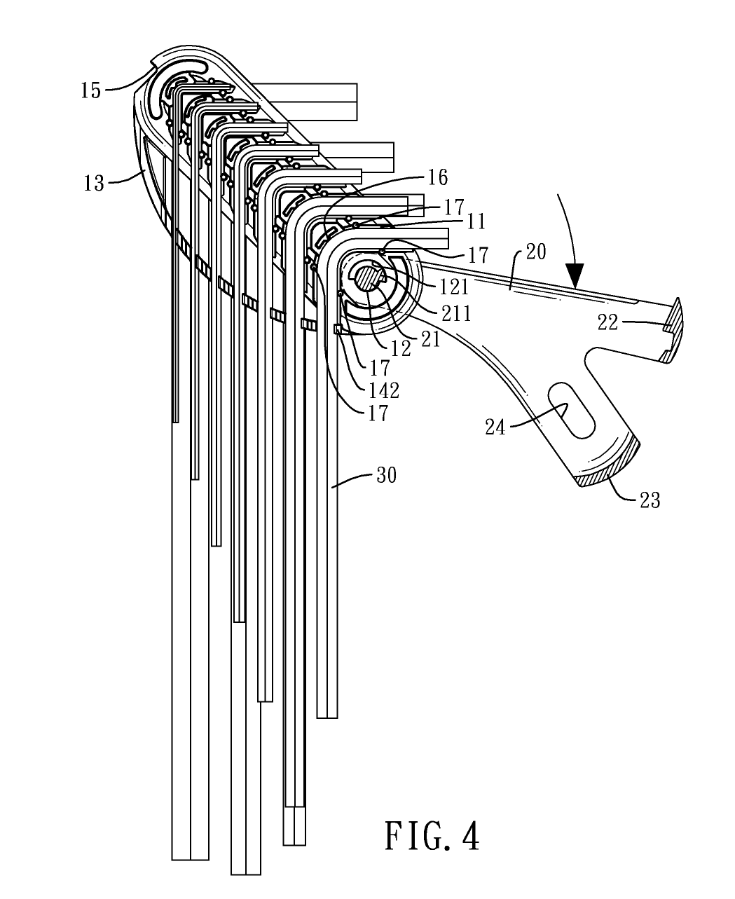

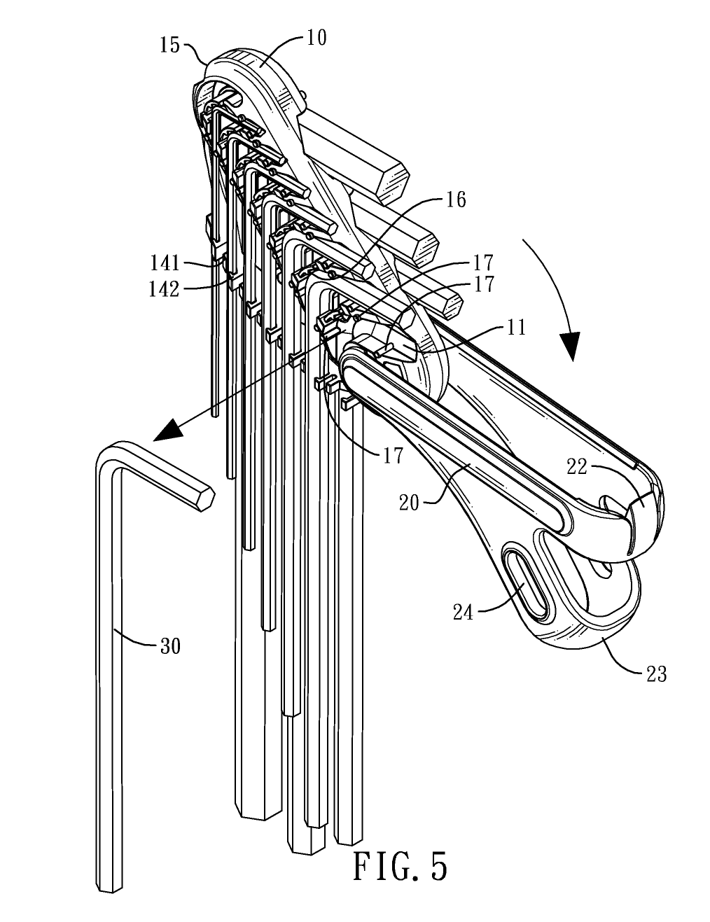

When a user wants to get one of the hexagonal wrenches 30 from the hexagonal wrench holding assembly in accordance with the present invention, with reference to FIGS. 4 and 5, the protecting cover 2 is rotated relative to the holding mount 1 until the inserting protrusions 211 abut with one of the positioning blocks 121 in the pivotal base 12. Then, the user can take one of the hexagonal wrenches 30 out of the mounting grooves 11 of the body 10 easily and conveniently without obstruction. Furthermore, the hexagonal wrench holding assembly in accordance with the present invention has a small volume and can be hanged on a user's waist or a hook by the hanging segment 23 of the casing 20.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hexagonal wrench holding assembly comprising
a holding mount having
a body having
two outer sides;
a connecting end;
a bottom;
a top;
multiple mounting grooves formed in the outer sides of the body at intervals and each mounting groove having
two internal surfaces;
a middle; and
multiple holding protrusions formed on and protruding from the internal surfaces of the mounting groove to abut and hold a hexagonal wrench;
a pivotal base formed on and protruding from the connecting end of the body and having a pivot hole formed through the pivotal base and having an inner surface and two ends; and
a locking recess formed on and protruding from the top of the body; and
a protecting cover pivotally connected to the holding mount and having
a casing pivotally connected to and mounted around the body and having
two ends, and one of the ends connected pivotally to the pivotal base; and
a locking protrusion formed on the other end of the casing and engaging the locking recess of the body to hold the protecting cover securely with the holding mount.

2. The hexagonal wrench holding assembly as claimed in claim 1, wherein each mounting groove has a curved spacer formed on and protruding from the middle of the mounting groove and having an inner protrusion.

3. The hexagonal wrench holding assembly as claimed in claim 2, wherein the body has a fixed seat formed on the bottom of the body and having
two sidewalls; and
multiple holding recesses formed in the sidewalls of the fixed seat, respectively aligning with the mounting grooves and each holding recess having
two sides;
an abutting arm formed on one of the sides of the holding recess; and
a holding claw formed on and protruding from the other side of the holding recess.

4. The hexagonal wrench holding assembly as claimed in claim 3, wherein
the pivotal base has two positioning blocks formed on and protruding from the inner surface respectively at the ends of the pivot hole of the pivotal base and each positioning block having two ends; and
the casing has two pivotal rods formed on the casing at the end on which the casing is pivotally connected to the pivotal base, and each pivotal rod has
an outer surface; and
an inserting protrusion formed on and protruding from the outer surface of the pivotal rod and mounted slidably in a corresponding end of the pivot hole of the pivotal base and selectively abutting with one of the ends of the positioning block in the corresponding end of the pivotal base to prevent the casing from knocking against the hexagonal wrenches.

5. The hexagonal wrench holding assembly as claimed in claim 4, wherein the casing has a hanging segment formed on the casing between the pivotal rods and the locking protrusion and having
two sidewalls; and
two hanging holes respectively formed through the sidewalls of the hanging segment.

6. The hexagonal wrench holding assembly as claimed in claim 1, wherein the body has a fixed seat formed on the bottom of the body and having
two sidewalls; and
multiple holding recesses formed in the sidewalls of the fixed seat, respectively aligning with the mounting grooves and each holding recess having
two sides;
an abutting arm formed on one of the sides of the holding recess; and
a holding claw formed on and protruding from the other side of the holding recess.

7. The hexagonal wrench holding assembly as claimed in claim 6, wherein
the pivotal base has two positioning blocks formed on and protruding from the inner surface respectively at the ends of the pivot hole of the pivotal base and each positioning block having two ends; and
the casing has two pivotal rods formed on the casing at the end which the casing is pivotally connected to the pivotal base, and each pivotal rod has
an outer surface; and
an inserting protrusion formed on and protruding from the outer surface of the pivotal rod and mounted slidably in a corresponding end of the pivot hole of the pivotal base and selectively abutting with one of the ends of the positioning blocks in the corresponding end of the pivotal base to prevent the casing from knocking against the hexagonal wrenches.

8. The hexagonal wrench holding assembly as claimed in claim 7, wherein the casing has a hanging segment formed on the casing between the pivotal rod and the locking protrusion and having
two sidewalls; and
two hanging holes respectively formed through the sidewalls of the hanging segment.

9. The hexagonal wrench holding assembly as claimed in claim 1, wherein
the pivotal base has a positioning block formed on and protruding from the inner surface respectively at the ends of the pivot hole of the pivotal base and each positioning block having two ends; and
the casing has two pivotal rods formed on the casing at the end which the casing is pivotally connected to the pivotal base, and each pivotal rod has
an outer surface; and
an inserting protrusion formed on and protruding from the outer surface of the pivotal rod and mounted slidably in a corresponding end of the pivot hole of the pivotal base and selectively abutting with one of the ends of the positioning block in the corresponding end of the pivotal base to prevent the casing from knocking against the hexagonal wrenches.

10. The hexagonal wrench holding assembly as claimed in claim 1, wherein the casing has a hanging segment formed on the casing between the pivotal rod and the locking protrusion and having
two sidewalls; and
two hanging holes respectively formed through the sidewalls of the hanging segment.
